(19) United States
(12) Patent Application Publication
(10) Pub. No.: US 2015/0024696 A1
(43) Pub. Date: Jan. 22, 2015

(54) MOBILE TERMINAL FOR AUTOMATICALLY ADJUSTING ANTENNA MATCHING AND CONTROL METHOD THEREFOR

(71) Applicant: HUIZHOU TCL MOBILE COMMUNICATION CO., LTD., HUIZHOU, GD (CN)

(72) Inventor: Xin Jin, Huizhou (CN)

(21) Appl. No.: 14/382,616

(22) PCT Filed: Mar. 18, 2013
(86) PCT No.: PCT/CN2013/072792

§ 371 Date: Sep. 3, 2014

(30) Foreign Application Priority Data
Jun. 28, 2012 (CN) 201210217625.4

(51) Int. Cl. H04B 1/40; H04B 17/00

(52) U.S. Cl. CPC H04B 1/40; H04B 17/00
USPC 455/77

(57) ABSTRACT

A mobile terminal for automatically adjusting antenna matching, and a control method thereof, are provided. By determining whether an RSSI value is less than a preset value, a mobile terminal, and a control method thereof, may send an SPI control signal according to a judgment result, and an SPI control interface may transmits the SPI control signal to an antenna matching module to control a magnitude of variable capacitance and variable inductance. Thereby antenna matching impedance may be adjusted to increase an RSSI value. A mobile terminal, and a control method thereof, may include a good communication signal and high call quality.

### TECHNICAL FIELD

The present disclosure relates to the field of communication technology, and in particular to a mobile terminal for automatically adjusting antenna matching and a control method thereof.

### BACKGROUND

Currently, RSSI (Received Signal Strength Indication) is frequently used in cell phone communications to judge link quality and represent a strength of a communication signal. Generally, a signal is considered to be good when an RSSI is at least 90 dbm. When an RSSI value is less than 70 dbm, such phenomena as offline, crosstalk, poor quality of speech, poor networking quality, and the like may appear during communications. An RSSI value is related to such factors as wireless environment, signal strength, speech frequency and antenna matching and the like. In cell phone design, a receiving capacity of an antenna is usually matched to an optimum behavior by adjusting a matched impedance of an antenna matching circuit, thereby, improving an RSSI value. Existing antenna matching circuits are typically π type matching circuits where associated capacitance and inductance values are fixed. By changing a grounding or parallel conditions of capacitance and inductance, such as increasing series inductance, as illustrated in an accompanying matched impedance schematic view of a smith chart in the prior art, a final matched impedance falls surrounding a circle center of the smith chart closer to the circle center. A better matching of impedance results in a higher efficiency of an antenna, such that an RSSI value is higher, and vice versa.

With recent developments of communication technologies, frequency bands included in cell phones are also gradually increased. For example, smartphones regularly have 5 and 6 frequency bands. More frequency bands provide more base station signals that can be selected, which may increase call completion rate of cell phones, may keep calls uninterrupted, may obtain excellent speech quality and communication coverage. However, increasing frequency bands raises a higher requirement on design of antennas, and particularly on antenna matching. When a cell phone is designed with one frequency band, an optimal antenna matching circuit impedance may be included. However, when a cell phone has 5 frequency bands at the same time, the cell phone is typically designed to search a balance point in the 5 frequency bands so as to meet matching requirements of all the frequency bands. Matched impedance, obtained in this manner, has low adaptability with each frequency band, and a receiving capacity of an antenna cannot be adjusted flexibly with a change of a frequency band. Particularly, when seizing a frequency band in a region having more cell phones, or when a signal penetrating power is not strong in a place with intensive buildings, an RSSI signal of a cell phone may be reduced due to environmental influence. Thus decreasing speech quality.

### SUMMARY

A mobile terminal is provided for automatically adjusting antenna matching to meet multi-frequency band requirements when a talking frequency band is changed and/or has poor speech quality.

A mobile terminal for automatically adjusting antenna matching may include a baseband processing module for monitoring and determining an RSSI value, outputting an SPI control signal, and calculating the RSSI value according to antenna matching impedance. The mobile terminal may also include an SPI control interface for transmitting the SPI control signal, via a baseband processing module, to an antenna matching module under an RSSI adjusting mode. The mobile terminal may further include a radio frequency transmitting-receiving module for modulating and demodulating signals processed by the baseband processing module and a radio frequency front end module. The radio frequency front end module may further perform filtering and function amplification on signals processed by the radio frequency transmitting-receiving module and the antenna matching module. The antenna matching module may further perform adjusting a value of an antenna matching impedance. The mobile terminal may further include an antenna for irradiating and receiving wireless signals.

One end of a baseband processing module may be connected to one end of an antenna matching module through an SPI control interface Another end of the baseband processing module may be connected to another end of the antenna matching module through a radio frequency transmitting-receiving module and a radio frequency front end module in series. The antenna matching module may also be connected to an antenna.

A control method for automatically adjusting antenna matching of a may include starting an RSSI monitoring mode of a mobile terminal during startup and monitoring, by a baseband processing module, an RSSI value in real time, and determining whether the RSSI value is less than a preset frequency band. If the RSSI value is less than a preset frequency band, entering, by the mobile terminal, an RSSI adjusting mode, transmitting, by the baseband processing module, an SPI control signal to an antenna matching module through an SPI control interface, and adjusting, by the antenna matching module, a value of antenna matching impedance according to the SPI control signal. Otherwise, continuously monitoring the RSSI value.

Adjusting, by the antenna matching module, the value of antenna matching impedance may include transmitting, by the baseband processing module, the SPI control signal to the antenna matching module through the SPI control interface, controlling, by the SPI control signal, a magnitude of variable capacitance and variable inductance inside the antenna matching module, and generating, by the antenna matching module, matched impedance according to the adjusted variable capacitance and/or variable inductance. The method may further include calculating, by the baseband processing module, the RSSI value according to the matched inductance of the antenna matching module, and determining whether the adjusted RSSI value is less than a preset frequency band. If the adjusted RSSI value is less than a preset frequency band, transmitting, by the baseband processing module, an SPI control signal to an antenna matching module through an SPI control interface, and adjusting, by the antenna matching module, a value of antenna matching impedance according to the SPI control signal. Otherwise, finishing the adjustment, and quitting the RSSI adjusting mode.

A control method for automatically adjusting antenna matching of a mobile terminal may include starting an RSSI monitoring mode of the mobile terminal during startup and monitoring, by a baseband processing module, an RSSI value in real time, and determining whether the RSSI value is less than a preset frequency band. If the RSSI value is less than a preset frequency band, entering, by the mobile terminal, an RSSI adjusting mode and transmitting, by a baseband processing module, an SPI control signal to an antenna matching module through an SPI control interface, and adjusting, by the antenna matching module, the value of antenna matching impedance according to the SPI control signal. Otherwise, continuously monitoring the RSSI value.

The control method may further include judging, by a baseband processing module, whether an adjusted RSSI value is less than a preset frequency band. If the adjusted RSSI value is less than a preset frequency band, transmitting, by a baseband processing module, an SPI control signal to an antenna matching module through an SPI control interface, and adjusting, by the antenna matching module, the value of antenna matching impedance according to the SPI control signal. Otherwise, finishing the adjusting, and quitting the RSSI adjusting mode.

A mobile terminal for automatically adjusting antenna matching, and the control method thereof, may monitor an RSSI value through a baseband processing module. When an RSSI value is less than a preset value, a mobile terminal, and a control method thereof, may send an SPI control signal, and an SPI control interface may transmit the SPI control signal to an antenna matching module. Once the SPI control signal is transmitted, an antenna matching module may control a magnitude of variable capacitance and variable inductance inside the antenna matching module according to the received SPI control signal. Thereby a value of an antenna matching impedance may be changed, such as increasing an RSSI value, obtaining a better communication signal, and ensuring excellent speech quality.

### BRIEF DESCRIPTION OF DRAWINGS

In order to illustrate the technical solutions, various embodiments are described in conjunction with the accompanying drawings. The specific embodiments are not intended to limit the scope of the claimed invention in any way.

FIG. 1 depicts a matched impedance schematic of a smith chart of the prior art;

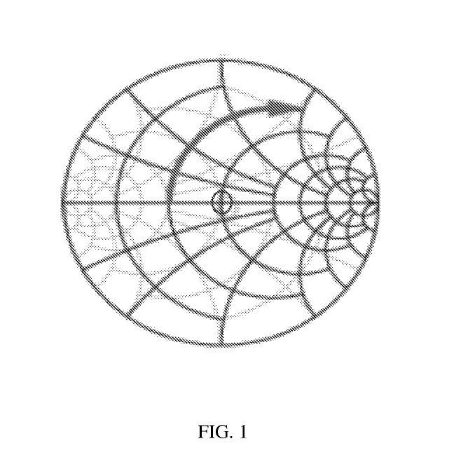

FIG. 2 depicts a structure block diagram of an example mobile terminal for automatically adjusting antenna matching;

FIG. 3 depicts a structure schematic of an example antenna matching module of a mobile terminal;

FIG. 4 depicts a flow chart of an example control method for automatically adjusting antenna matching;

FIG. 5 depicts an impedance schematic when closing a cover of a flip phone in the prior art; and

FIG. 6 depicts an impedance schematic when opening a cover of the flip phone in the prior art.

### DETAILED DESCRIPTION

A mobile terminal for automatically adjusting antenna matching, and a control method thereof, are provided. To illustrate objectives, technical solutions and effects details of various embodiments are described with reference to the accompanying drawings. It should be understood that the specific embodiments described here are for illustrative purposes and are not intended to limit the scope of the claimed invention in any way.

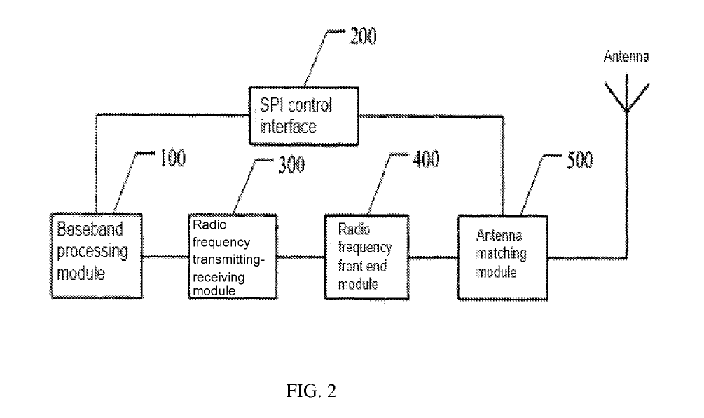

Turning to FIG. 2, a structure block diagram of a mobile terminal for automatically adjusting antenna matching is depicted. As shown in FIG. 2, a mobile terminal for automatically adjusting antenna matching may include a baseband processing module 100, an SPI control interface 200, a radio frequency transmitting-receiving module 300, a radio frequency front end module 400, an antenna matching module 500 and an antenna.

A baseband processing module 100 may be used for monitoring and determining an RSSI value, outputting an SPI control signal, and calculating the RSSI value according to antenna matching impedance. Other functions of a baseband processing module 100, such as signal encoding/decoding and the like will not be described in detail.

An SPI control interface 200 may be used for transmitting an SPI control signal via a baseband processing module 100 to an antenna matching module 500 under an RSSI adjusting mode. A radio frequency transmitting-receiving module 300 may be used for modulating and demodulating signals processed by a baseband processing module and a radio frequency front end module. A radio frequency front end module 400 may be used for performing filtering and power amplification on signals processed by a radio frequency transmitting-receiving module and an antenna matching module. An antenna matching module 500 may be used for adjusting a magnitude of variable capacitance and/or variable inductance to change a value of an antenna matching impedance. An antenna may be used for irradiating and receiving a wireless signal.

A radio frequency transmitting-receiving module 300 may perform down-conversion on a signal transmitted by a baseband processing module 100 to reduce a signal frequency, and/or may perform up-conversion on a signal transmitted by a radio frequency front end module 400 to improve a signal frequency.

One end of a baseband processing module 100 may be connected to one end of an antenna matching module 500 through an SPI control interface 200. The other end of the baseband processing module 100 may be connected to another end of the antenna matching module 500 through a radio frequency transmitting-receiving module 300 and a radio frequency front end module 400 in sequence. An antenna matching module 500 may also be connected to the antenna.

An element in an antenna matching module 500 may be variable capacitance and/or variable inductance. A mobile terminal may be a cell phone, a tablet computer or a data card.

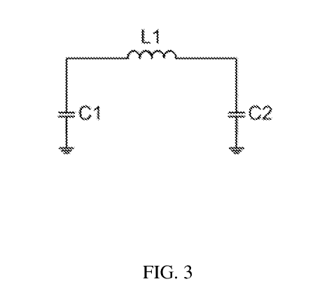

With reference to FIG. 3, a structure schematic of an example antenna matching module of a mobile terminal is depicted. A mobile terminal may include a first capacitance C1, a second capacitance C2 and a first inductance L1. One end of the first capacitance C1 may be connected to one end of the second capacitance C2 through the first inductance L1. Both another end of the first capacitance C1 and another end of the second capacitance C2 may be grounded. The first capacitance C1 and the second capacitance C2 may be variable capacitance. The first inductance L1 may be variable inductance.

A first capacitance C1, a second capacitance C2 and a first inductance L1 may form a π type matching circuit. In a π type matching circuit, electronic elements may be variable capacitances or variable inductances or a combination of two variable inductances and one variable capacitance, or a combination of two variable capacitances and one variable inductance. Electronic elements in an antenna matching module may be combined into an antenna matching circuit of other forms aside from a π type matching circuit.

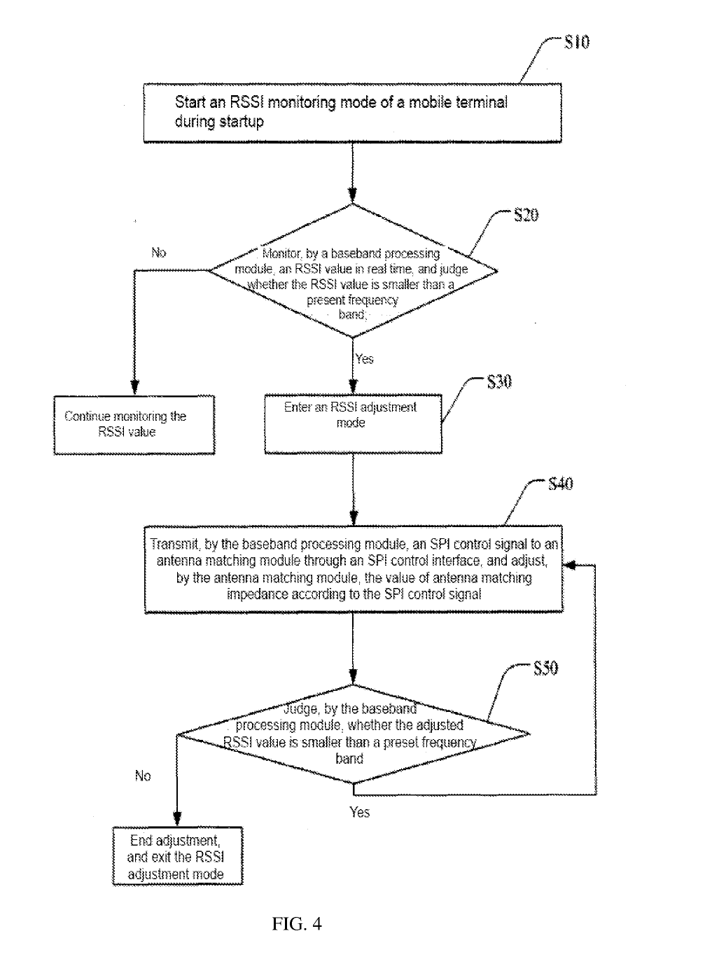

Turning to FIG. 4, a control method may include starting an RSSI monitoring mode of a mobile terminal during startup, wherein the mobile terminal may automatically start the RSSI monitoring mode while startup.

The control method may further include monitoring, by a baseband processing module, an RSSI value in real time, and determining whether the RSSI value is less than a preset frequency band. If the RSSI value is less than a preset frequency band, an RSSI adjustment mode may be entered. Otherwise, the RSSI value may be continuously monitored.

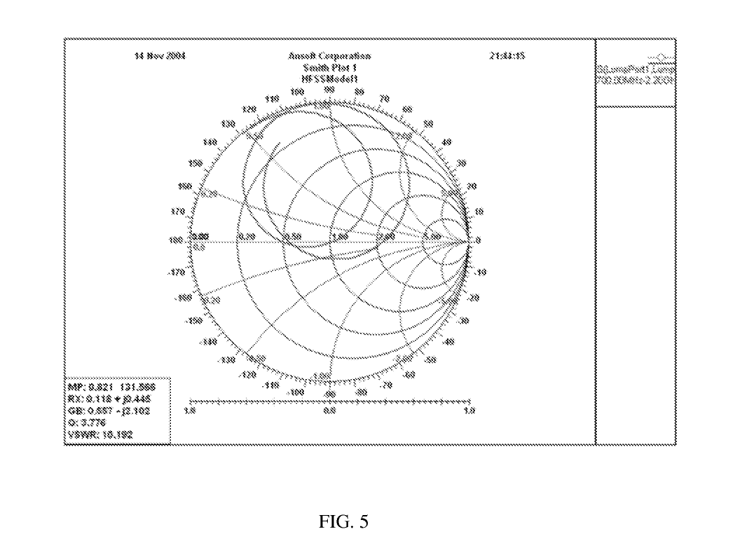

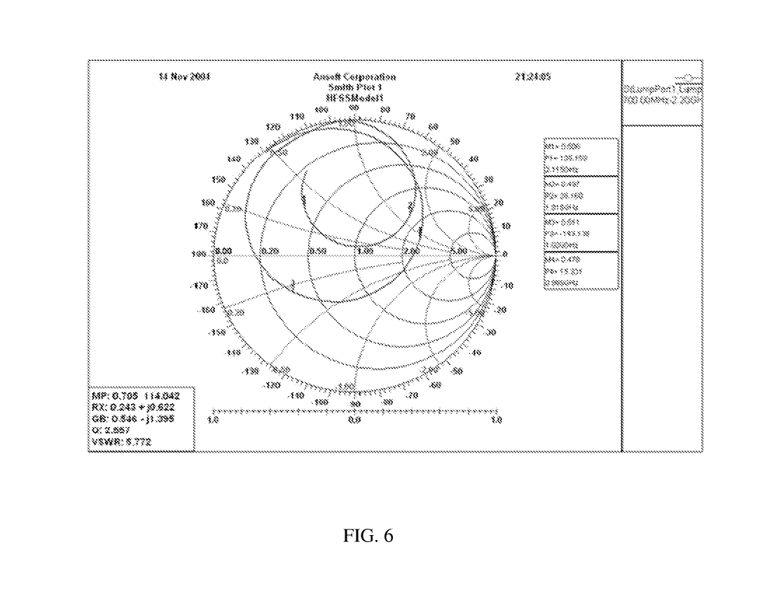

A preset frequency band may be 70 dbm. Generally a signal may be considered good when an RSSI is 90 dbm. If an RSSI value is less than 70 dbm, a speech quality may be influenced. An RSSI value may be changed with a changing of such factors as wireless environment, location signal strength, speech frequency and antenna matching and the like. Particularly, FIG. 5 and FIG. 6 are respectively an impedance schematic when closing a cover of a flip phone in the prior art and an impedance schematic when opening the cover of the flip phone in the prior art. The flip phone has different impedances when opening and closing the cover, thus causing different antenna matching, and thereby influencing a change of an associated RSSI value.

A control method may further include transmitting, by a baseband processing module, an SPI control signal to an antenna matching module through an SPI control interface, and adjusting, by an antenna matching module, a value of antenna matching impedance according to the SPI control signal. An SPI (Serial Peripheral Interface) control interface may transmit a serial data control command according to a specific transport protocol thereof, to realize data communications between a baseband processing module and an antenna matching module. That is, an SPI control signal may be a digital signal, which may be a binary code such as 010111. SPI control signals may be different each time the signals are sent, and the specific data may be controlled by a baseband processing module.

An antenna matching module may adopt a matching circuit combined by a variable capacitance circuit and/or variable inductance, as depicted in, for example, FIG. 3. A magnitude of a variable capacitance and/or a variable inductance may be adjusted according to a binary code sent by an SPI control signal, thus obtaining matched impedance.

A control method may also include judging, by a baseband processing module, whether an adjusted RSSI value is less than a preset frequency band. If an adjusted RSSI value is less than a preset frequency band, transmitting, by a baseband processing module, an SPI control signal to an antenna matching module through an SPI control interface, and adjusting, by an antenna matching module, a value of antenna matching impedance according to the SPI control signal. Otherwise, finishing an adjusting, and quitting an RSSI adjusting mode.

Generally when a matched impedance is 50 ohm, an efficiency of an antennary is optimum and a communication signal is best. The baseband processing module may compare a magnitude of a calculated matched impedance with 50 ohm. The closer to the 50 ohm that the matched impedance is, the higher an RSSI value; and the further from the 50 ohm that the matched impedance is, the lower the RSSI value.

If an RSSI value can reach 70 dbm above after a first adjustment, the adjustment may be finished, the RSSI adjusting mode may be concluded and the RSSI monitoring mode may be returned. If an RSSI value after a first adjustment is still less than 70 dbm, a baseband processing module may send an SPI control signal again to adjust a magnitude of a matched impedance.

An RSSI value may be monitored in real time through a baseband processing module. When an RSSI value is reduced and less than a preset frequency band due to a change of a frequency band or other conditions, a baseband processing module may send an SPI control signal and an SPI control interface may transmit the SPI control signal to an antenna matching module to control a magnitude of variable capacitance and/or variable inductance. Thereby, an antenna matching impedance may be adjusted to increase an RSSI value, adapt to a new frequency band, enhance signals, and ensure excellent talking environments.

The foregoing embodiments are for illustrative purposes and are not intended to limit the scope of the claimed invention. Any equivalence structure or equivalence flow transformation shall fall within the scope of the claimed invention.

1. A mobile terminal for automatically adjusting antenna matching, comprising:
a baseband processing module that monitors and determines an RSSI value, outputs an SPI control signal, and calculates the RSSI value according to antenna matching impedance;
an SPI control interface that transmits the SPI control signal to an antenna matching module under an RSSI adjusting mode;
a radio frequency transmitting-receiving module that modulates and demodulates signals processed by the baseband processing module and a radio frequency front end module;
the radio frequency front end module performs filtering and power amplification on signals processed by the radio frequency transmitting-receiving module and the antenna matching module;
the antenna matching module adjusts a value of antenna matching impedance; and
an antenna that irradiates and receives a wireless signal;
a first end of the baseband processing module is connected to a first end of the antenna matching module through the SPI control interface; a second end of the baseband processing module is connected to a second end of the antenna matching module through the radio frequency transmitting-receiving module and the radio frequency front end module in sequence; and
the antenna matching module is also connected to the antenna.

2. The mobile terminal according to claim 1, wherein the antenna matching module includes variable capacitance and/or inductance.

3. The mobile terminal according to claim 1, wherein the mobile terminal is one of: a cell phone, a tablet computer or a data card.

4. A method for automatically adjusting antenna matching adopting in a mobile terminal, the method comprising:
starting an RSSI monitoring mode of the mobile terminal during startup;
monitoring, by a baseband processing module, an RSSI value in real time, and determining whether the RSSI value is less than a preset frequency band; if the RSSI value is determined to be less than the present frequency band, entering, by the mobile terminal, an RSSI adjusting mode and
transmitting, by the baseband processing module, an SPI control signal to an antenna matching module through an SPI control interface, and adjusting, by the antenna matching module, a value of antenna matching impedance according to the SPI control signal, comprising:
transmitting, by the baseband processing module, the SPI control signal to the antenna matching module through the SPI control interface;
controlling, by the SPI control signal, a magnitude of variable capacitance and variable inductance inside the antenna matching module; and
generating, by the antenna matching module, matched impedance according to the adjusted variable capacitance and/or variable inductance;
if the RSSI value is greater than or equal to the present frequency band, continuously monitoring the RSSI value;
calculating, by the baseband processing module, an RSSI value according to the matched inductance of the antenna matching module, and determining whether the adjusted RSSI value is less than a preset frequency band; if the RSSI value is determined to be less than the preset frequency band,
transmitting, by the baseband processing module, an SPI control signal to the antenna matching module through the SPI control interface, and adjusting, by the antenna matching module, a value of antenna matching impedance according to the SPI control signal; and
if the RSSI value is greater than or equal to the preset frequency band, finishing adjusting and exiting the RSSI adjusting mode.

5. The method for automatically adjusting antenna matching according to claim 4, wherein the SPI control signal is a digital signal.

6. The method for automatically adjusting antenna matching according to claim 4, wherein the preset frequency band is 70 dbm.

7. A method for automatically adjusting antenna matching in a mobile terminal, the method comprising:
starting an RSSI monitoring mode of the mobile terminal during startup;
monitoring, by a baseband processing module, an RSSI value in real time, and determining whether the RSSI value is less than a preset frequency band; if the RSSI value is determined to be less than the preset frequency band, entering, by the mobile terminal, an RSSI adjusting mode and
transmitting, by the baseband processing module, an SPI control signal to an antenna matching module through an SPI control interface, and adjusting, by the antenna matching module, a value of antenna matching impedance according to the SPI control signal;
if the RSSI value is determined to be greater than or equal to the preset frequency band, continuously monitoring the RSSI value; and
determining, by the baseband processing module, whether an adjusted RSSI value is less than the preset frequency band; if the RSSI value is less than the preset frequency band, transmitting, by the baseband processing module, an SPI control signal to the antenna matching module through the SPI control interface, and adjusting, by the antenna matching module, a value of antenna matching impedance according to the SPI control signal; otherwise, finishing the adjusting, and exiting the RSSI adjusting mode.

8. The method for automatically adjusting antenna matching according to claim 7, further comprising:
transmitting, by the baseband processing module, the SPI control signal to the antenna matching module through the SPI control interface;
controlling, by the SPI control signal, a magnitude of variable capacitance and variable inductance inside the antenna matching module; and
generating, by the antenna matching module, matched impedance according to an adjusted variable capacitance and/or variable inductance.

9. The method for automatically adjusting antenna matching according to claim 7, further comprising:
calculating, by the baseband processing module, an RSSI value according to a magnitude of the matched impedance of the antenna matching module.

10. The method for automatically adjusting antenna matching according to claim 7, wherein the SPI control signal is a digital signal.

11. The method for automatically adjusting antenna matching according to claim 7, wherein the preset frequency band is 70 dbm.

12. The method for automatically adjusting antenna matching according to claim 4, wherein the antenna matching module includes variable capacitance and/or inductance.

13. The method for automatically adjusting antenna matching according to claim 7, wherein the antenna matching module includes variable capacitance and/or inductance.

14. The method for automatically adjusting antenna matching according to claim 4, wherein the mobile terminal is one of: a cell phone, a tablet computer or a data card.

15. The method for automatically adjusting antenna matching according to claim 7, wherein the mobile terminal is one of: a cell phone, a tablet computer or a data card.

16. The mobile terminal according to claim 1, wherein the SPI control signal is a digital signal.

17. The mobile terminal according to claim 1, wherein the preset frequency band is 70 dbm.

18. The method for automatically adjusting antenna matching according to claim 4, wherein the antenna matching module includes a π type matching circuit.

19. The method for automatically adjusting antenna matching according to claim 7, wherein the antenna matching module includes a π type matching circuit.

20. The mobile terminal according to claim 1, wherein the antenna matching module includes a π type matching circuit.
